(19) United States
(12) Patent Application Publication
(10) Pub. No.: US 2013/0162916 A1
(43) Pub. Date: Jun. 27, 2013

(54) TV/DVD/Cable Monitor Shelf

(71) Applicant: Frederick Williamson, Lugoff, SC (US)

(72) Inventor: Frederick Williamson, Lugoff, SC (US)

(21) Appl. No.: 13/447,229

(22) Filed: Apr. 15, 2012

Related U.S. Application Data
(60) Provisional application No. 61/580,201, filed on Dec. 24, 2011.

(51) Int. Cl. H04N 5/655

(52) U.S. Cl. CPC H04N 5/655
USPC 348/836

(57) ABSTRACT

The invention is a cantilevered shelf designed to be used with a flat screen television or computer monitor providing a location for the placement of auxiliary small electronic equipment such as a DVD player, cable converter box or game console. The vertical support for the horizontal shelf can be secured to the TV's wall mounting brackets, to the TV itself or to a wall near where the TV will be mounted.

### CROSS REFERENCE TO RELATED APPLICATIONS

Provisional Patent Application No.: 61/580,201

Filing Date: Dec. 24, 2011Relationship:

Provisional application was for the same invention

### STATEMENT REGARDING FEDERALLY SPONSORED RESEARCH OR DEVELOPMENT

This invention was not made by an agency of the United States Government nor under a contract with an agency of the United States Government.

### PARTIES TO JOINT RESEARCH AGREEMENT

Not Applicable.

### REFERENCE TO SEQUENCE LISTING

Not Applicable.

### BACKGROUND OF THE INVENTION

Liquid crystal display (LCD), light-emitting diode (LED) and plasma display televisions are increasingly popular in American homes. Generically referred to as flat screen or flat display TVs, these units provide for large viewing areas yet are far lighter and thinner than the traditional television sets that utilized cathode ray tubes (CRT). The relatively light weight and thinness of the flat screen TV enables them to be mounted on walls or above fireplaces.

However, this popular placement of the flat screen TVs gives rise to the dilemma of where to locate auxiliary equipment such as DVD players, game consoles, cable converters, etc. The purpose of this invention is to provide a convenient location for placement of such auxiliary equipment. The invention (as shown in FIG. 1) is a cantilevered shelf secured by attachment directly to the back of the flat screen TV or to the mounting brackets used to secure the TV to the wall.

### BRIEF SUMMARY OF THE INVENTION

The invention is a cantilevered shelf designed to be used with a flat screen television or computer monitor providing a location for the placement of auxiliary equipment such as a cable converter, DVD or game console. The horizontal shelf may be extended out over the top of the television while the vertical part of the invention is secured to the TV's wall mounting brackets, to the TV itself or to a wall near where the TV will be mounted. The invention may also be attached such that the horizontal shelf extends in the opposite direction away from the front of the television (FIG. 2). A cushioned surface, such as a felt pad, may be affixed to the top of the horizontal shelf to provide a non-skid surface for the auxiliary equipment.

The preferred embodiment of the TV/DVD/Cable Monitor Shelf is a single piece of 14 gauge aluminum folded at a 90-degree angle. The horizontal top part of the invention is cantilevered over the TV to provide the shelf for the auxiliary equipment. The vertical portion of the invention is notched in such a manner as to fit onto the TV's wall mounting bracket and is secured in place using commercially available clamps.

### BRIEF DESCRIPTION OF THE SEVERAL VIEWS OF THE DRAWING

FIG. 1 shows the invention with the horizontal shelf (A) cantilevered over the top of the television. The vertical support (B) is secured to the television's wall mount with screws or clamps.

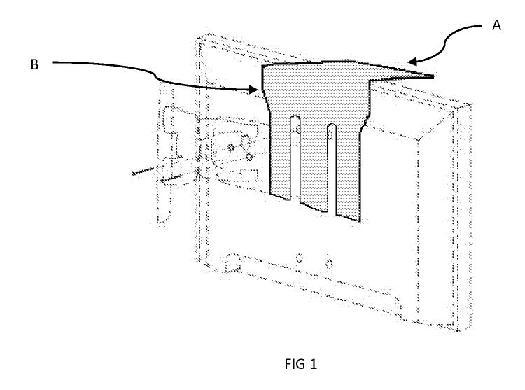

FIG. 2 shows the invention with the horizontal shelf (A) oriented in back of the television.

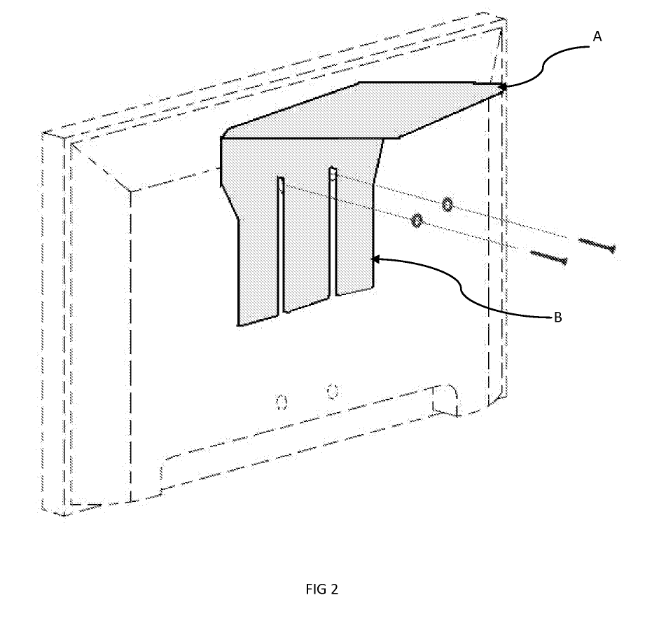

### DETAILED DESCRIPTION OF THE INVENTION

Liquid crystal display (LCD), light-emitting diode (LED) and plasma display televisions comprise the majority of the television market in the United States. Generically referred to as flat screen or flat display TVs, these units provide for large viewing areas yet are far lighter and thinner than the traditional television sets that utilized cathode ray tubes (CRT). The relatively light weight and thinness of the flat screen TV enables them to be mounted on walls or above fireplaces.

However, this popular placement of the flat screen TVs gives rise to the dilemma of where to locate auxiliary equipment such as DVD players, game consoles, cable converters, etc. The purpose of this invention is to provide a convenient location for placement of such auxiliary equipment.

The invention is a cantilevered shelf that extends over the top of the flat screen television. The shelf is supported by a vertical member that secures to the back of the TV or to the TV's wall mounting bracket. This method of securing the shelf allows the shelf to stay in a fixed position relative to the TV if the TV unit is swiveled on it base or brackets.

Previous United States Patents and/or Patent Applications for above TV shelves for auxiliary components (U.S. Pat. No. 5,842,423 (issued 1998) and United States Patent Application 2006/0238662) rely on the size and depth of the CRT to support the shelf. Neither of these inventions would be suitable for use with modern flat screen televisions as the flat screen TV does not have sufficient depth to support a shelf in the method described in U.S. Pat. No. 5,842,423 or application 2006/0238662.

The preferred embodiment of the TV/DVD/Cable Monitor Shelf is a single piece of 14 gauge aluminum folded at a 90-degree angle. The horizontal top part of the invention is cantilevered over the TV to provide the shelf for the auxiliary equipment. The vertical portion of the invention is notched in such a manner as to fit onto the TV's wall mounting bracket and is secured in place using commercially available clamps.

A potential patent classification for this invention is Class 108 (Horizontally Supported Planar Surfaces), Subclass 162/165 (Foldable Component: Integrally Formed From Sheet). Class 108 class includes “rigid, planar, supporting surfaces having structure to support the surface in a horizontal plane.” Subclass 162 includes those devices where the support structure for a horizontal surface is foldably connected to the surface with indented Subclass 165 relating to those inventions where the horizontal surface and the supporting structure are formed from a single piece of material such as a sheet of metal or plastic.

The invention claimed is:

1. An L-shaped shelf comprising a horizontal flat member and vertical notched support.

2. The apparatus according to claim 1, where said shelf is comprised of a single piece of metal or synthetic material formed into an L-shape.

3. The apparatus according to claim 1, where said shelf is comprised of horizontal and vertical members attached to each other along one edge to form an L-shape.

4. The apparatus according to claim 1, where a non-skid material is attached to the horizontal member to provide a cushioned surface.

5. The apparatus according to claim 1, where the vertical member is notched in a manner where it can be secured to a television or a television wall-mount bracket.

6. A method utilizing the apparatus of claim 1 to support auxiliary small electronics utilized with a flat-screen television or computer monitor.
